(19) United States
(12) Patent Application Publication
(10) Pub. No.: US 2019/0106176 A1
(43) Pub. Date: Apr. 11, 2019

(54) CONTROL METHOD, MOBILE APPARATUS, BRAKE LEVER DEVICE AND BRAKING DEVICE

(71) Applicant: NINEBOT (BEIJING) TECH CO., LTD., Beijing (CN)

(72) Inventors: Jie LUO, Beijing (CN); Zhongyuan CHEN, Beijing (CN); Ye WANG, Beijing (CN); Fengxin WANG, Beijing (CN); Haibo ZHU, Beijing (CN); Weifeng MAO, Beijing (CN)

(21) Appl. No.: 16/089,599

(22) PCT Filed: Mar. 31, 2017
(86) PCT No.: PCT/CN2017/079146

§ 371 Date: Sep. 28, 2018

(30) Foreign Application Priority Data
Apr. 1, 2016 (CN) 201610204341.X
Jul. 15, 2016 (CN) 201620752059.0

(51) Int. Cl. B62L 3/02

(52) U.S. Cl. CPC B62L 3/02

(57) ABSTRACT

Mobile apparatus comprises first brake component and second brake component. Control method comprises: obtaining first operation, and determining braking strategy according to the first operation; determining, according to the braking strategy, first parameter corresponding to the first brake component and second parameter corresponding to the second brake component; controlling the first brake component according to the first parameter to perform first braking procedure; generating control signal corresponding to the second parameter, and controlling the second brake component according to the control signal to perform second braking procedure. Brake lever device comprises: brake lever hood, brake lever mounted on the brake lever hood, and brake force detection device disposed in the brake lever hood. The brake force detection device generates corresponding braking intensity signal with respect to the distance moved by the brake lever. The braking intensity signal generates electronic braking force corresponding to the distance moved by the brake lever.

### CROSS REFERENCE TO RELATED APPLICATIONS

This application is based on, and claims benefit of priority to, Chinese Applications No. 201610204341.X filed on Apr. 1, 2016 and No. 201620752059.0 filed on Jul. 15, 2016. Disclosure of all of the Chinese Applications is hereby incorporated by reference in its entirety.

### TECHNICAL FIELD

The present disclosure relates to control technology, and in particular to a controlling method, mobile equipment, a braking crank device, and a braking device.

### BACKGROUND

An electric car finds wide use due to environment friendliness and convenience thereof. There are various kinds of electric cars, such as an electric bicycle, an electric tricycle, an electric four-wheeler, etc. Braking performance of an electric car is a key factor considered by a user. Good braking performance may guarantee user safety.

An existing electric car brakes as follows. When it is detected during a ride that a braking crank has been pressed, power supply of a motor may be cut off. In this case, braking is implemented completely by a mechanical structure. Such a braking mode provides a weak braking strength, which leads to a long braking distance. In this case, a dangerous accident tends to happen. In addition, a conventional electric braking crank, limited by an internal structure thereof, may provide, during braking, a controller with but a simple signal, such that the controller may control a braking part to output but a constant electronic braking force, in which case a braking force may be weakened greatly.

### SUMMARY

Embodiments herein provide a controlling method, mobile equipment, a braking crank device, and a braking device.

According to an embodiment herein, a controlling method applies to mobile equipment. The mobile equipment has a first braking part and a second braking part. The controlling method includes:

acquiring a first operation; determining, according to the first operation, a braking strategy;

determining, according to the braking strategy, a first parameter corresponding to the first braking part and a second parameter corresponding to the second braking part;

controlling, according to the first parameter, first braking on the mobile equipment by the first braking part;

generating a control signal corresponding to the second parameter; and controlling, according to the control signal, second braking on the mobile equipment by the second braking part.

The first braking part may be connected to a moving structure. The mobile equipment may further include a sensor for detecting a course of the moving structure.

The acquiring a first operation; determining, according to the first operation, a braking strategy may include:

in response to acquiring the first operation, detecting, using the sensor, a course of the moving structure corresponding to the first operation; and

determining, according to the course, the braking strategy.

The first parameter may indicate a braking strength of the first braking part. The second parameter may indicate a braking strength of the second braking part. The braking strategy may include:

in response to the course being within a first range, setting both the first parameter and the second parameter to zero;

in response to the course being within a second range, setting the first parameter to be greater than zero and the second parameter to zero; or setting the first parameter to zero and the second parameter to be greater than zero; and/or

in response to the course being within a third range, setting both the first parameter and the second parameter to be greater than zero.

The course within the first range may be less than the course within the second range. The course within the second range may be less than the course within the third range.

The first parameter may indicate a braking strength of the first braking part. The second parameter may indicate a braking strength of the second braking part. The braking strategy may include:

in response to the course being within a fourth range, setting both the first parameter and the second parameter to zero; and/or

in response to the course being within a fifth range, setting both the first parameter and the second parameter to be greater than zero.

The course within the fourth range may be less than the course within the fifth range.

The first parameter may indicate a braking strength of the first braking part. The second parameter may indicate a braking strength of the second braking part. The braking strategy may include:

in response to the course being within a sixth range, setting the first parameter to be greater than zero and the second parameter to zero; or setting the first parameter to zero and the second parameter to be greater than zero; and/or

in response to the course being within a seventh range, setting both the first parameter and the second parameter to be greater than zero.

The course within the sixth range may be less than the course within the seventh range.

The braking strategy may further include:

in response to the first parameter being greater than zero, increasing the first parameter as the course increases; and/or

in response to the second parameter being greater than zero, increasing the second parameter as the course increases.

The controlling, according to the control signal, second braking on the mobile equipment by the second braking part may include:

controlling the second braking part to determine, according to the control signal, a locking duration and a driving duration of a driving part within a period of time pre-determined;

controlling the driving part to stop driving within the locking duration.

Mobile equipment according to an embodiment herein has a first braking part and a second braking part. The mobile equipment includes a processor.

The processor is arranged for: acquiring a first operation; determining, according to the first operation, a braking strategy; determining, according to the braking strategy, a first parameter corresponding to the first braking part and a second parameter corresponding to the second braking part.

The first braking part may be arranged for: performing, according to the first parameter, first braking on the mobile equipment.

The second braking part may be arranged for: generating a control signal corresponding to the second parameter; performing, according to the control signal, second braking on the mobile equipment.

The first braking part may be connected to a moving structure. The mobile equipment may further include a sensor for detecting a course of the moving structure.

The sensor may be arranged for: in response to acquiring the first operation, detecting a course of the moving structure corresponding to the first operation.

The processor may be further arranged for: determining, according to the course, the braking strategy.

The first parameter may indicate a braking strength of the first braking part. The second parameter may indicate a braking strength of the second braking part. The braking strategy may include:

in response to the course being within a first range, setting both the first parameter and the second parameter to zero;

in response to the course being within a second range, setting the first parameter to be greater than zero and the second parameter to zero; or setting the first parameter to zero and the second parameter to be greater than zero; and/or

in response to the course being within a third range, setting both the first parameter and the second parameter to be greater than zero.

The course within the first range may be less than the course within the second range. The course within the second range may be less than the course within the third range.

The first parameter may indicate a braking strength of the first braking part. The second parameter may indicate a braking strength of the second braking part. The braking strategy may include:

in response to the course being within a fourth range, setting both the first parameter and the second parameter to zero; and/or

in response to the course being within a fifth range, setting both the first parameter and the second parameter to be greater than zero.

The course within the fourth range may be less than the course within the fifth range.

The first parameter may indicate a braking strength of the first braking part. The second parameter may indicate a braking strength of the second braking part. The braking strategy may include:

in response to the course being within a sixth range, setting the first parameter to be greater than zero and the second parameter to zero; or setting the first parameter to zero and the second parameter to be greater than zero; and/or

in response to the course being within a seventh range, setting both the first parameter and the second parameter to be greater than zero.

The course within the sixth range may be less than the course within the seventh range.

The braking strategy may further include:

in response to the first parameter being greater than zero, increasing the first parameter as the course increases; and/or

in response to the second parameter being greater than zero, increasing the second parameter as the course increases.

The second braking part may be further arranged for: determining, according to the control signal, a locking duration and a driving duration of a driving part within a period of time pre-determined; controlling the driving part to stop driving within the locking duration.

A braking crank device according to an embodiment herein includes:

a braking crank case;

a braking crank installed on the braking crank case; and

a braking strength detecting device arranged for generating, in response to a movement of a handle of the braking crank during braking, a signal of a braking strength corresponding to the movement.

The braking strength detecting device is set inside the braking crank case.

The signal of the braking strength is arranged for generating a first force corresponding to a distance by which the handle of the braking crank has moved. A size of the first force changes as the distance changes. The first force is an electronic braking force.

The braking strength detecting device may be a Hall element. The braking crank device may further include a magnet.

The magnet may be arranged for moving with displacement of the handle of the braking crank during braking.

The Hall element may be arranged for: detecting strength of a magnetic field generated by the magnet during movement, and generating, according to the strength of the magnetic field detected, the signal of the braking strength corresponding to the movement.

The magnet may be set on an extending part integral to the handle.

The extending part may be set with a first hole for connection. The braking crank case may be set with a second hole for connection corresponding to the first hole for connection.

A braking crank shaft may be arranged for installing the braking crank on the braking crank case by passing through the first hole for connection and the second hole for connection.

The braking crank case may be set with a Hall base. The Hall element may be secured on the Hall base. The Hall element may be arranged for not moving with the displacement of the handle of the braking crank.

The signal of the braking strength may be arranged for instructing to stop outputting a driving force that drives mobile equipment.

A braking device according to an embodiment herein includes a braking crank device. The braking crank device includes:

a braking crank case;

a braking crank installed on the braking crank case; and

a braking strength detecting device arranged for generating, in response to a movement of a handle of the braking crank during braking, a signal of a braking strength corresponding to the movement.

The braking strength detecting device is set inside the braking crank case.

The braking device further includes:

a braking part; and

a controller arranged for: generating, according to the signal of the braking strength, a first control signal; controlling, according to the first control signal, electric braking on a driving part by the braking part. A size of a braking force thereof changes as a distance by which the handle of the braking crank has moved changes.

The braking strength detecting device is arranged for outputting the signal of the braking strength to the controller.

The braking strength detecting device may be a Hall element. The braking crank device may further include a magnet.

The magnet may be arranged for moving with displacement of the handle of the braking crank during braking.

The Hall element may be arranged for: detecting strength of a magnetic field generated by the magnet during movement, and generating, according to the strength of the magnetic field detected, the signal of the braking strength corresponding to the movement.

The magnet may be set on an extending part integral to the handle.

The extending part may be set with a first hole for connection. The braking crank case may be set with a second hole for connection corresponding to the first hole for connection.

A braking crank shaft may be arranged for installing the braking crank on the braking crank case by passing through the first hole for connection and the second hole for connection.

The braking crank case may be set with a Hall base. The Hall element may be secured on the Hall base. The Hall element may be arranged for not moving with the displacement of the handle of the braking crank.

The controller may be arranged for generating, according to the signal of the braking strength, a second control signal to stop outputting a driving force that drives mobile equipment.

Mobile equipment according to an embodiment herein includes an aforementioned braking device.

With a technical solution according to at least one embodiment herein, a first operation is acquired. A braking strategy is determined according to the first operation. A first parameter corresponding to a first braking part and a second parameter corresponding to a second braking part are determined according to the braking strategy. First braking on mobile equipment by the first braking part is controlled according to the first parameter. A control signal corresponding to the second parameter is generated. Second braking on the mobile equipment by the second braking part is controlled according to the control signal. With embodiments herein, mobile equipment is braked using two braking parts. A first braking part brakes through a mechanical structure. A second braking part brakes through a circuit structure. A braking strength is enhanced by using both the first braking part and the second braking part, reducing a braking distance, enhancing user safety.

With a technical solution according to at least one embodiment herein, a braking crank is installed on a braking crank case. A braking strength detecting device generates, in response to a movement of a handle of the braking crank during braking, a signal of a braking strength corresponding to the movement. The braking strength detecting device is set inside the braking crank case. The signal of the braking strength is arranged for generating a first force corresponding to a distance by which the handle of the braking crank has moved. A size of the first force changes as the distance changes. The first force is an electronic braking force. During braking, the signal of the braking strength corresponding to the change in the distance by which the handle has moved is generated, thereby generating an electronic braking force corresponding to strength of a braking signal, such that a continuous increasing electronic braking force may be generated during braking, thereby providing a continuous increasing braking force, increasing the braking force, enhancing a braking result. By providing braking with an electronic braking force of a size changing with change in a distance by which a handle of a braking crank has moved, somatosensory control of a size of an electronic braking force by a user is enabled, enhancing a braking precision, improving braking experience.

### BRIEF DESCRIPTION OF THE DRAWINGS

FIG. 1 is a flowchart of a controlling method according to an embodiment herein.

FIG. 2 is a flowchart of a controlling method according to an embodiment herein.

FIG. 3 is a flowchart of a controlling method according to an embodiment herein.

FIG. 4 is a diagram of an entity of mobile equipment according to an embodiment herein.

FIG. 5 is a diagram of a course of a moving part according to an embodiment herein.

FIG. 6 is a diagram of a structure of mobile equipment according to an embodiment herein.

FIG. 7 is a diagram of a structure of mobile equipment according to an embodiment herein.

FIG. 8 is a diagram of a structure of a braking crank device according to an embodiment herein.

FIG. 9 is an exploded view of a structure of a braking crank device according to an embodiment herein.

FIG. 10 is a diagram of a structure of a braking device according to an embodiment herein.

### DETAILED DESCRIPTION

Embodiments herein are elaborated below with reference to the drawings to allow a more thorough understanding of a feature and technical content of an embodiment herein. The drawings herein are but for reference and explanation, and are not intended to limit an embodiment herein.

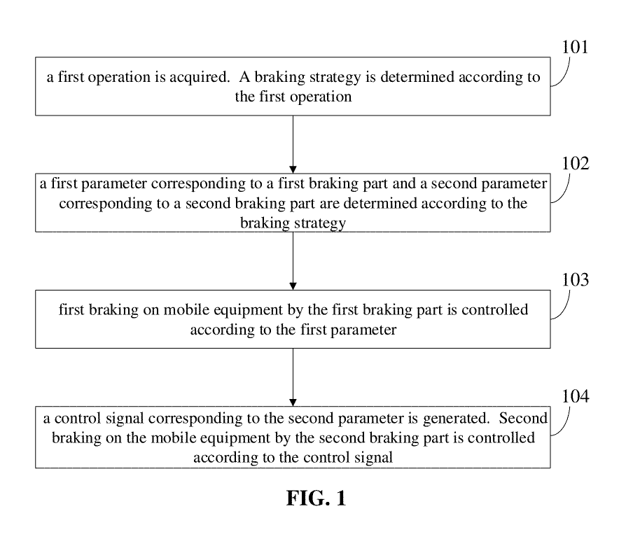

FIG. 1 is a flowchart of a controlling method according to an embodiment herein. The controlling method applies to mobile equipment having a first braking part and a second braking part. As shown in FIG. 1, the controlling method includes options as follows.

In option 101, a first operation is acquired. A braking strategy is determined according to the first operation.

The mobile equipment may be an electric car. The electric car may be an electric scooter, an electric bicycle, an electric tricycle, an electric four-wheeler, etc.

The mobile equipment may have a first braking part and a second braking part. The first braking part may brake through a mechanical structure. The second braking part may brake through a circuit structure. Accordingly, the first braking part may also be known as a mechanical brake. The second braking part may also be known as an electric brake.

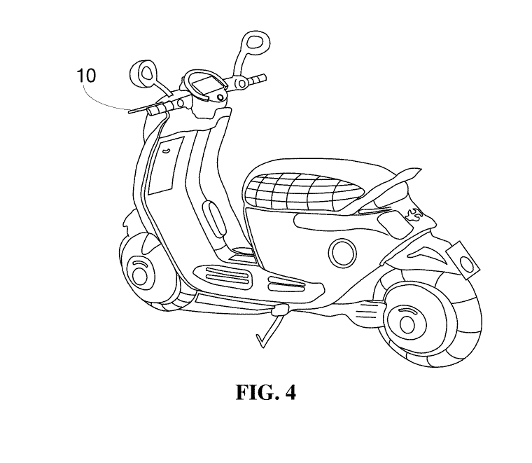

The first operation may be triggered by a user. The user may perform the first operation on a mechanical control of the mobile equipment, such that a structure of the mechanical control may be changed. Referring to FIG. 4, the mobile equipment may be an electric bicycle. A braking crank of the electric bicycle may be the mechanical control. The user may trigger the first operation by clenching the braking crank of the electric bicycle. The mechanical control may be connected to the first braking part through a mechanical structure. A sensor for detecting a clenching course of the mechanical structure may be provided on the mechanical control. The sensor may be connected to the second braking part through a circuit structure. In an embodiment herein, the user may perform the first operation on an electronic control of the mobile equipment. The electronic control may be connected to the first braking part through an electric structure. The electronic control may be connected to the second braking part through a circuit structure.

Having acquired the first operation, the mobile equipment may determine the braking strategy corresponding to the first operation. The first braking part and the second braking part may brake according to the braking strategy. With the braking strategy, a braking strength may be enhanced by using both the first braking part and the second braking part.

In option 102, a first parameter corresponding to a first braking part and a second parameter corresponding to a second braking part are determined according to the braking strategy.

With the braking strategy, braking strengths of the first braking part and the second braking part may be regulated flexibly. The braking strength of the first braking part may be determined through the first parameter. The braking strength of the second braking part may be determined through the second parameter. The control strategy herein may include information on at least a first parameter and a second parameter. The first parameter corresponding to the first braking part and the second parameter corresponding to the second braking part may be determined according to the braking strategy.

As the first braking part brakes through a mechanical structure, the first parameter may be a parameter for adjusting the mechanical structure of the first braking part. For example, the first braking part may be a damping part. The damping part may be set near a wheel. When the damping part is pressed against the wheel, the damping part may impede the wheel's movement, thereby braking the mobile equipment. The first parameter may be closeness or tightness between the damping part and the wheel, i.e., how close or tight the damping part is pressed against the wheel. The greater the closeness/tightness, i.e., the closer/tighter the damping part is pressed against the wheel, the stronger a braking force is. The less the closeness/tightness, the weaker the braking force is. When the damping part is not pressed against the wheel, the braking strength may be zero.

As the second braking part brakes through a circuit structure, the second parameter may be a circuit parameter for adjusting the second braking part. The second braking part per se may be the circuit structure. A driving part of the mobile equipment may be a motor, for example. Rotation of the motor may drive a wheel of the mobile equipment, thereby driving the mobile equipment. The second braking part may brake the mobile equipment as follows. An electric current may be applied to the motor (in a duration which may be determined based on the second parameter), to short circuit a winding of the motor intermittently. When the winding of the motor is short circuited intermittently, rotation of the motor may be stopped, such that no power may be provided to the wheel, thereby braking the mobile equipment.

In option 103, first braking on mobile equipment by the first braking part is controlled according to the first parameter.

The first parameter may be for adjusting the mechanical structure of the first braking part. The mobile equipment may be braked by adjusting the mechanical structure of the first braking part according to the first parameter.

Referring to FIG. 4, the mobile equipment may be an electric bicycle. The user may trigger the first braking by the first braking part by clenching a braking crank of the electric bicycle. The braking crank may apply the first braking on the mobile equipment by tightening the first braking part through a brake line. The first braking part may be a damping part. The damping part may be set near a wheel. When the damping part is pressed against the wheel, the damping part may impede the wheel's movement, thereby braking the mobile equipment.

In option 104, a control signal corresponding to the second parameter is generated. Second braking on the mobile equipment by the second braking part is controlled according to the control signal.

The second parameter may be a circuit parameter for adjusting the second braking part. The mobile equipment may be braked by adjusting a circuit parameter of the second braking part according to the second parameter.

A driving part of the mobile equipment may be a motor, for example. Rotation of the motor may drive a wheel of the mobile equipment, thereby driving the mobile equipment. The second braking part may brake the mobile equipment as follows. The control signal corresponding to the second parameter may be generated. The control signal may be sent to the motor, such that an electric current corresponding to the control signal may be applied to the motor (in a duration which may be determined based on the second parameter), to short circuit a winding of the motor intermittently. When the winding of the motor is short circuited intermittently, rotation of the motor may be stopped, such that no power may be provided to the wheel, thereby braking the mobile equipment.

The second braking part may determine, according to the control signal, a locking duration and a driving duration of a driving part within a period of time pre-determined. The second braking part may control the driving part to stop driving within the locking duration. The driving part may be a motor, for example. A three-phase circuit or a two-phase circuit of the motor may be short circuited within the locking duration to stop driving.

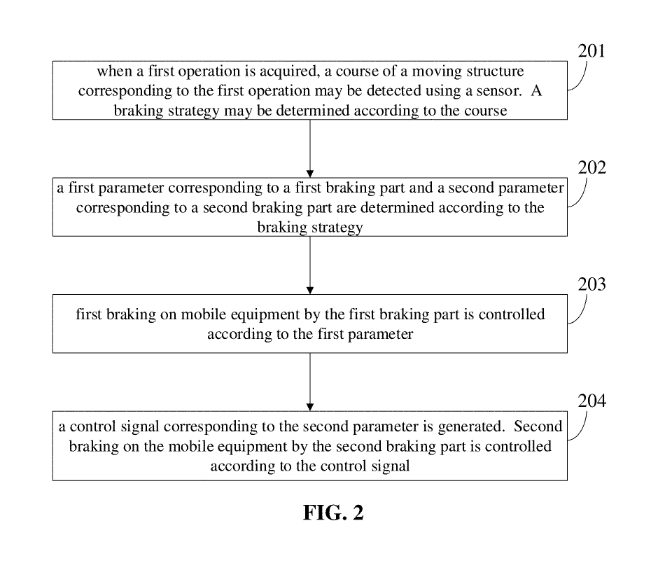

FIG. 2 is a flowchart of a controlling method according to an embodiment herein. The controlling method applies to mobile equipment having a first braking part and a second braking part. The first braking part may be connected to a moving structure. The mobile equipment may further include a sensor for detecting a course of the moving structure. As shown in FIG. 2, the controlling method may include options as follows.

In option 201, when a first operation is acquired, a course of a moving structure corresponding to the first operation may be detected using a sensor. A braking strategy may be determined according to the course.

The mobile equipment may be an electric car. The electric car may be an electric scooter, an electric bicycle, an electric tricycle, an electric four-wheeler, etc.

The mobile equipment may have a first braking part and a second braking part. The first braking part may brake through a mechanical structure. The second braking part may brake through a circuit structure. Accordingly, the first braking part may also be known as a mechanical brake. The second braking part may also be known as an electric brake.

The first operation may be triggered by a user. The user may perform the first operation on a moving structure of the mobile equipment, such that a course of the moving structure may be changed. Referring to FIG. 4, the mobile equipment may be an electric bicycle. A braking crank of the electric bicycle may be the moving structure. The user may trigger the first operation by clenching the braking crank of the electric bicycle. The moving structure may be connected to the first braking part through a mechanical structure. A sensor for detecting a clenching course may be provided on the mechanical control. The sensor may be connected to the second braking part through a circuit structure.

Having acquired the first operation, the sensor may detect the course of the moving structure corresponding to the first operation. The braking strategy may be determined according to the course. The first braking part and the second braking part may brake according to the braking strategy. With the braking strategy, a braking strength may be enhanced by using both the first braking part and the second braking part.

The sensor may be a potentiometer, a Hall inductive element, etc.

In option 202, a first parameter corresponding to a first braking part and a second parameter corresponding to a second braking part are determined according to the braking strategy.

With the braking strategy, braking strengths of the first braking part and the second braking part may be regulated flexibly. The braking strength of the first braking part may be determined through the first parameter. The braking strength of the second braking part may be determined through the second parameter. The control strategy herein may include information on at least a first parameter and a second parameter. The first parameter corresponding to the first braking part and the second parameter corresponding to the second braking part may be determined according to the braking strategy.

As the first braking part brakes through a mechanical structure, the first parameter may be a parameter for adjusting the mechanical structure of the first braking part. For example, the first braking part may be a damping part. The damping part may be set near a wheel. When the damping part is pressed against the wheel, the damping part may impede the wheel's movement, thereby braking the mobile equipment. The first parameter may be closeness or tightness between the damping part and the wheel, i.e., how close or tight the damping part is pressed against the wheel. The greater the closeness/tightness, i.e., the closer/tighter the damping part is pressed against the wheel, the stronger a braking force is. The less the closeness/tightness, the weaker the braking force is. When the damping part is not pressed against the wheel, the braking strength may be zero.

As the second braking part brakes through a circuit structure, the second parameter may be a circuit parameter for adjusting the second braking part. The second braking part per se may be the circuit structure. A driving part of the mobile equipment may be a motor, for example. Rotation of the motor may drive a wheel of the mobile equipment, thereby driving the mobile equipment. The second braking part may brake the mobile equipment as follows. An electric current may be applied to the motor (in a duration which may be determined based on the second parameter), to short circuit a winding of the motor intermittently. When the winding of the motor is short circuited intermittently, rotation of the motor may be stopped, such that no power may be provided to the wheel, thereby braking the mobile equipment.

In option 203, first braking on mobile equipment by the first braking part is controlled according to the first parameter.

The first parameter may be for adjusting the mechanical structure of the first braking part. The mobile equipment may be braked by adjusting the mechanical structure of the first braking part according to the first parameter.

Referring to FIG. 4, the mobile equipment may be an electric bicycle. The user may trigger the first braking by the first braking part by clenching a braking crank of the electric bicycle. The braking crank may apply the first braking on the mobile equipment by tightening the first braking part through a brake line. The first braking part may be a damping part. The damping part may be set near a wheel. When the damping part is pressed against the wheel, the damping part may impede the wheel's movement, thereby braking the mobile equipment.

In option 204, a control signal corresponding to the second parameter is generated. Second braking on the mobile equipment by the second braking part is controlled according to the control signal.

A voltage signal output by the sensor may be the control signal. The sensor may be provided with a power supply of 5.0V. When the course of the moving structure is zero, the sensor may output 1.0V. When the course of the moving structure is maximal, the sensor may output 4.0V. A voltage value here may be exemplary.

The second parameter may be a circuit parameter for adjusting the second braking part. The mobile equipment may be braked by adjusting a circuit parameter of the second braking part according to the second parameter.

A driving part of the mobile equipment may be a motor, for example. Rotation of the motor may drive a wheel of the mobile equipment, thereby driving the mobile equipment. The second braking part may brake the mobile equipment as follows. The control signal corresponding to the second parameter may be generated. The control signal may be sent to the motor, such that an electric current corresponding to the control signal may be applied to the motor (in a duration which may be determined based on the second parameter), to short circuit a winding of the motor intermittently. When the winding of the motor is short circuited intermittently, rotation of the motor may be stopped, such that no power may be provided to the wheel, thereby braking the mobile equipment.

The second braking part may determine, according to the control signal, a locking duration and a driving duration of a driving part within a period of time pre-determined. The second braking part may control the driving part to stop driving within the locking duration. The driving part may be a motor, for example. A three-phase circuit or a two-phase circuit of the motor may be short circuited within the locking duration to stop driving.

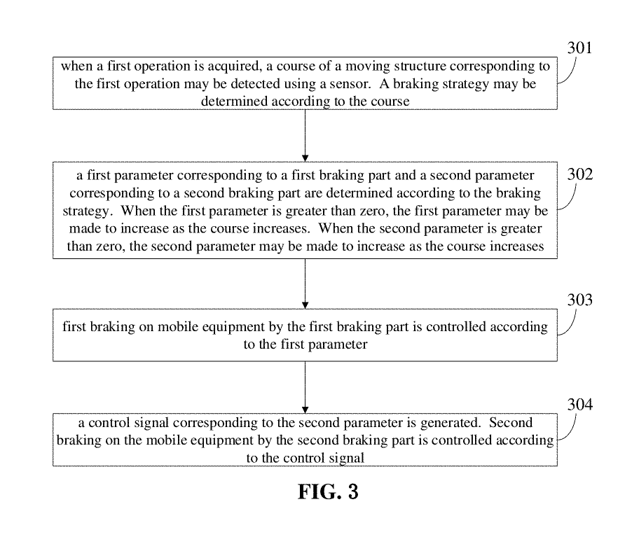

FIG. 3 is a flowchart of a controlling method according to an embodiment herein. The controlling method applies to mobile equipment having a first braking part and a second braking part. The first braking part may be connected to a moving structure. The mobile equipment may further include a sensor for detecting a course of the moving structure. As shown in FIG. 3, the controlling method may include options as follows.

In option 301, when a first operation is acquired, a course of a moving structure corresponding to the first operation may be detected using a sensor. A braking strategy may be determined according to the course.

The mobile equipment may be an electric car. The electric car may be an electric scooter, an electric bicycle, an electric tricycle, an electric four-wheeler, etc.

The mobile equipment may have a first braking part and a second braking part. The first braking part may brake through a mechanical structure. The second braking part may brake through a circuit structure. Accordingly, the first braking part may also be known as a mechanical brake. The second braking part may also be known as an electric brake.

The first operation may be triggered by a user. The user may perform the first operation on a moving structure of the mobile equipment, such that a course of the moving structure may be changed. Referring to FIG. 4, the mobile equipment may be an electric bicycle. A braking crank of the electric bicycle may be the moving structure. The user may trigger the first operation by clenching the braking crank of the electric bicycle. The moving structure may be connected to the first braking part through a mechanical structure. A sensor for detecting a clenching course may be provided on the mechanical control. The sensor may be connected to the second braking part through a circuit structure.

Having acquired the first operation, the sensor may detect the course of the moving structure corresponding to the first operation. The braking strategy may be determined according to the course. The first braking part and the second braking part may brake according to the braking strategy. With the braking strategy, a braking strength may be enhanced by using both the first braking part and the second braking part.

In option 302, a first parameter corresponding to a first braking part and a second parameter corresponding to a second braking part are determined according to the braking strategy. When the first parameter is greater than zero, the first parameter may be made to increase as the course increases. When the second parameter is greater than zero, the second parameter may be made to increase as the course increases.

With the braking strategy, braking strengths of the first braking part and the second braking part may be regulated flexibly. The braking strength of the first braking part may be determined through the first parameter. The braking strength of the second braking part may be determined through the second parameter. The control strategy herein may include information on at least a first parameter and a second parameter. The first parameter corresponding to the first braking part and the second parameter corresponding to the second braking part may be determined according to the braking strategy.

The first parameter may indicate a braking strength of the first braking part. The second parameter may indicate a braking strength of the second braking part.

As the first braking part brakes through a mechanical structure, the first parameter may be a parameter for adjusting the mechanical structure of the first braking part. For example, the first braking part may be a damping part. The damping part may be set near a wheel. When the damping part is pressed against the wheel, the damping part may impede the wheel's movement, thereby braking the mobile equipment. The first parameter may be closeness or tightness between the damping part and the wheel, i.e., how close or tight the damping part is pressed against the wheel. The greater the closeness/tightness, i.e., the closer/tighter the damping part is pressed against the wheel, the stronger a braking force is. The less the closeness/tightness, the weaker the braking force is. When the damping part is not pressed against the wheel, the braking strength may be zero.

As the second braking part brakes through a circuit structure, the second parameter may be a circuit parameter for adjusting the second braking part. The second braking part per se may be the circuit structure. A driving part of the mobile equipment may be a motor, for example. Rotation of the motor may drive a wheel of the mobile equipment, thereby driving the mobile equipment. The second braking part may brake the mobile equipment as follows. An electric current may be applied to the motor (in a duration which may be determined based on the second parameter), to short circuit a winding of the motor intermittently. When the winding of the motor is short circuited intermittently, rotation of the motor may be stopped, such that no power may be provided to the wheel, thereby braking the mobile equipment.

According to the braking strategy, when the course is within a first range, both the first parameter and the second parameter may be set to zero.

According to the braking strategy, when the course is within a second range, the first parameter may be set to be greater than zero and the second parameter may be set to zero; or the first parameter may be set to zero and the second parameter may be set to be greater than zero.

According to the braking strategy, when the course is within a third range, both the first parameter and the second parameter may be set to be greater than zero,

The course within the first range may be less than the course within the second range. The course within the second range may be less than the course within the third range.

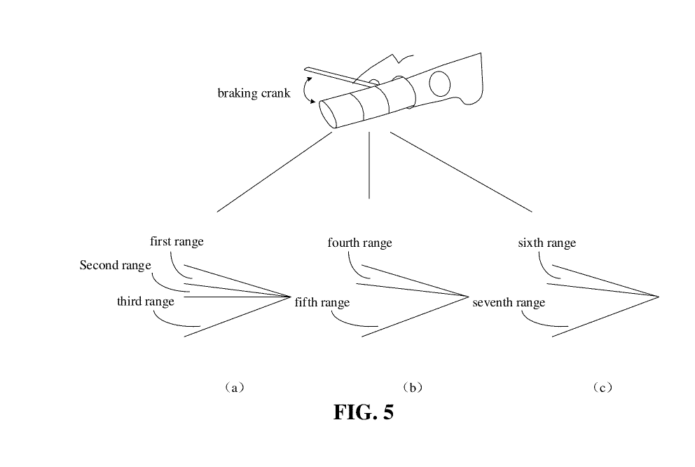

Referring to FIG. 5(a), assume that the moving structure may travel an idle course. For example, when the course of the moving structure falls within a first range (within a first quarter of a whole course), braking strengths of both the second braking part and the first braking part may be zero. When the course of the moving structure falls within a second range (from a first quarter to a second quarter of the whole course), the braking strength of either the first braking part or the second braking part is greater than zero. When the course of the moving structure falls within a third range (from the second quarter of the whole course to the whole course), the braking strengths of both the second braking part and the first braking part may be greater than zero.

According to the braking strategy, when the course is within a fourth range, both the first parameter and the second parameter may be set to zero.

According to the braking strategy, when the course is within a fifth range, both the first parameter and the second parameter may be set to be greater than zero.

The course within the fourth range may be less than the course within the fifth range.

Referring to FIG. 5(b), assume that the moving structure may travel an idle course. For example, when the course of the moving structure falls within a fourth range (within the first quarter of the whole course), braking strengths of both the second braking part and the first braking part may be zero. When the course of the moving structure falls within a fifth range (from the first quarter of the whole course to the whole course), the braking strengths of both the second braking part and the first braking part may be greater than zero.

According to the braking strategy, when the course is within a sixth range, the first parameter may be set to be greater than zero and the second parameter may be set to zero; or the first parameter may be set to zero and the second parameter may be set to be greater than zero.

According to the braking strategy, when the course is within a seventh range, both the first parameter and the second parameter may be set to be greater than zero,

The course within the sixth range may be less than the course within the seventh range.

Referring to FIG. 5(c), when the course of the moving structure falls within a sixth range (within the first quarter of the whole course), the braking strength of either the second braking part or the first braking part may be zero. When the course of the moving structure falls within a seventh range (from the first quarter of the whole course to the whole course), the braking strengths of both the second braking part and the first braking part may be greater than zero.

In option 303, first braking on mobile equipment by the first braking part is controlled according to the first parameter.

The first parameter may be for adjusting the mechanical structure of the first braking part. The mobile equipment may be braked by adjusting the mechanical structure of the first braking part according to the first parameter.

Referring to FIG. 4, the mobile equipment may be an electric bicycle. The user may trigger the first braking by the first braking part by clenching a braking crank of the electric bicycle. The braking crank may apply the first braking on the mobile equipment by tightening the first braking part through a brake line. The first braking part may be a damping part. The damping part may be set near a wheel. When the damping part is pressed against the wheel, the damping part may impede the wheel's movement, thereby braking the mobile equipment.

In option 304, a control signal corresponding to the second parameter is generated. Second braking on the mobile equipment by the second braking part is controlled according to the control signal.

The second parameter may be a circuit parameter for adjusting the second braking part. The mobile equipment may be braked by adjusting a circuit parameter of the second braking part according to the second parameter.

A driving part of the mobile equipment may be a motor, for example. Rotation of the motor may drive a wheel of the mobile equipment, thereby driving the mobile equipment. The second braking part may brake the mobile equipment as follows. The control signal corresponding to the second parameter may be generated. The control signal may be sent to the motor, such that an electric current corresponding to the control signal may be applied to the motor (in a duration which may be determined based on the second parameter), to short circuit a winding of the motor intermittently. When the winding of the motor is short circuited intermittently, rotation of the motor may be stopped, such that no power may be provided to the wheel, thereby braking the mobile equipment.

A voltage signal output by the sensor may be the control signal. The sensor may be provided with a power supply of 5.0V. When the course of the moving structure is zero, the sensor may output 1.0V. When the course of the moving structure is maximal, the sensor may output 4.0V. A voltage value here may be exemplary.

When two phases of a motor are short circuited with a duty cycle of less than 10%, no effective braking force may be generated. Therefore, 1.0V may correspond to a duty cycle of 10%. 4.0V may correspond to a duty cycle of 100%. When a sensor outputs 3V, two phases of the motor may be short circuited with a duty cycle of 70%.

The second braking part may determine, according to the control signal, a locking duration and a driving duration of a driving part within a period of time pre-determined. The second braking part may control the driving part to stop driving within the locking duration. The driving part may be a motor, for example. A three-phase circuit or a two-phase circuit of the motor may be short circuited within the locking duration to stop driving.

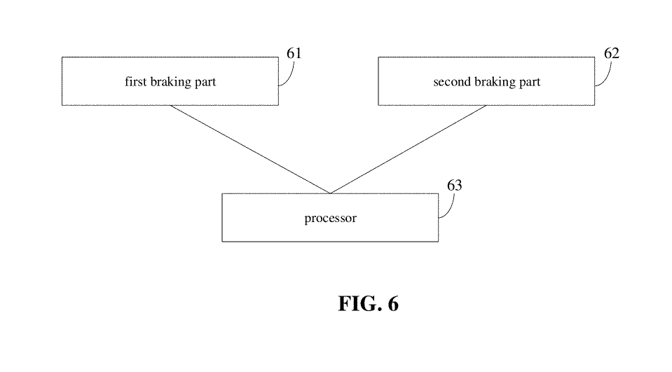

FIG. 6 is a diagram of a structure of mobile equipment according to an embodiment herein. As shown in FIG. 6, the mobile equipment has a first braking part 61 and a second braking part 62. The mobile equipment includes a processor 63.

The processor 63 is arranged for: acquiring a first operation; determining, according to the first operation, a braking strategy; determining, according to the braking strategy, a first parameter corresponding to the first braking part 61 and a second parameter corresponding to the second braking part 62.

The first braking part 61 is arranged for: performing, according to the first parameter, first braking on the mobile equipment.

The second braking part 62 is arranged for: generating a control signal corresponding to the second parameter; performing, according to the control signal, second braking on the mobile equipment.

Those skilled in the art may appreciate that a function implemented by a device in the mobile equipment shown in FIG. 6 may be understood with reference to description relevant to the controlling method.

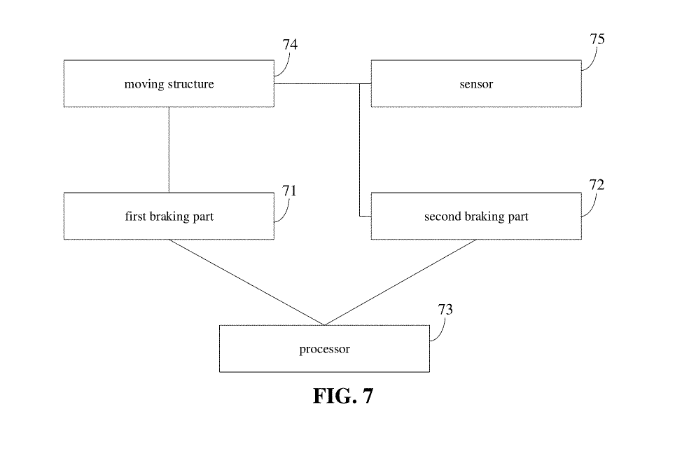

FIG. 7 is a diagram of a structure of mobile equipment according to an embodiment herein. As shown in FIG. 7, the mobile equipment has a first braking part 71 and a second braking part 72. The mobile equipment includes a processor 73.

The processor 73 is arranged for: acquiring a first operation; determining, according to the first operation, a braking strategy; determining, according to the braking strategy, a first parameter corresponding to the first braking part 71 and a second parameter corresponding to the second braking part 72.

The first braking part 71 is arranged for: performing, according to the first parameter, first braking on the mobile equipment.

The second braking part 72 is arranged for: generating a control signal corresponding to the second parameter; performing, according to the control signal, second braking on the mobile equipment.

The first braking part 71 may be connected to a moving structure 74. The mobile equipment may further include a sensor 75 for detecting a course of the moving structure 74.

The sensor 75 may be arranged for: in response to acquiring the first operation, detecting a course of the moving structure 74 corresponding to the first operation.

The processor 73 may further be arranged for: determining, according to the course, the braking strategy.

The first parameter may indicate a braking strength of the first braking part 71. The second parameter may indicate a braking strength of the second braking part 72.

According to the braking strategy, when the course is within a first range, both the first parameter and the second parameter may be set to zero.

According to the braking strategy, when the course is within a second range, the first parameter may be set to be greater than zero and the second parameter may be set to zero; or the first parameter may be set to zero and the second parameter may be set to be greater than zero.

According to the braking strategy, when the course is within a third range, both the first parameter and the second parameter may be set to be greater than zero,

The course within the first range may be less than the course within the second range. The course within the second range may be less than the course within the third range.

The first parameter may indicate a braking strength of the first braking part 71. The second parameter may indicate a braking strength of the second braking part 72.

According to the braking strategy, when the course is within a fourth range, both the first parameter and the second parameter may be set to zero.

According to the braking strategy, when the course is within a fifth range, both the first parameter and the second parameter may be set to be greater than zero.

The course within the fourth range may be less than the course within the fifth range.

The first parameter may indicate a braking strength of the first braking part 71. The second parameter may indicate a braking strength of the second braking part 72.

According to the braking strategy, when the course is within a sixth range, the first parameter may be set to be greater than zero and the second parameter may be set to zero; or the first parameter may be set to zero and the second parameter may be set to be greater than zero.

According to the braking strategy, when the course is within a seventh range, both the first parameter and the second parameter may be set to be greater than zero,

The course within the sixth range may be less than the course within the seventh range.

According to the braking strategy, when the first parameter is greater than zero, the first parameter may be made to increase as the course increases.

According to the braking strategy, when the second parameter is greater than zero, the second parameter may be made to increase as the course increases.

The second braking part 72 may further be arranged for: determining, according to the control signal, a locking duration and a driving duration of a driving part within a period of time pre-determined; controlling the driving part to stop driving within the locking duration.

Those skilled in the art may appreciate that a function implemented by a device in the mobile equipment shown in FIG. 7 may be understood with reference to description relevant to the controlling method.

A conventional electric braking crank, limited by an internal structure thereof, may provide, during braking, a controller with but a simple signal. Having received the signal, the controller may control a braking part to output a constant electronic braking force. That is, a conventional electric braking crank may serve as a normally open/closed switch. When a handle is clenched such that the handle reaches a maximal displacement thereof, the electric braking crank may output to the controller a signal indicating but to brake. Having received the signal, the controller may control a braking part to output a constant electronic braking force, in which case a braking force may be weakened greatly, which may lead to poor user experience during braking.

Accordingly, with embodiments herein, a braking crank is installed on a braking crank case. A braking strength detecting device generates, in response to a movement of a handle of the braking crank during braking, a signal of a braking strength corresponding to the movement. The braking strength detecting device is set inside the braking crank case. The signal of the braking strength is arranged for generating a first force corresponding to a distance by which the handle of the braking crank has moved (i.e., the course). A size of the first force may change as the distance changes. The first force is an electronic braking force.

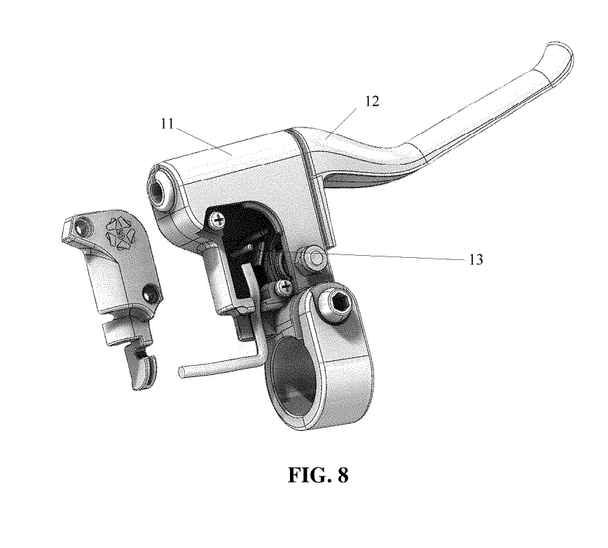

As shown in FIG. 8, a braking crank device according to an embodiment herein includes a braking crank case 11, a braking crank 12, and a braking strength detecting device 13.

The braking crank 12 is installed on the braking crank case 11.

The braking strength detecting device 13 is set inside the braking crank case 11. The braking strength detecting device is arranged for generating, in response to a movement of a handle of the braking crank 12 during braking, a signal of a braking strength corresponding to the movement.

The signal of the braking strength is arranged for generating a first force corresponding to a distance by which the handle of the braking crank has moved (i.e., the course). A size of the first force may change as the distance changes. The first force is an electronic braking force.

With a braking crank device according to an embodiment herein, while a handle of a braking crank 12 is being clenched gradually by a user, i.e., while a distance by which the handle has moved is changing gradually, a braking strength detecting device 13 may detect a signal of a braking strength corresponding to the constantly changing distance, to generate an electronic braking force corresponding to the constantly changing distance under control of a controller.

The signal of the braking strength may instruct to stop outputting a driving force that drives mobile equipment.

That is, while the mobile equipment is moving, the signal of the braking strength may instruct the controller to stop providing the mobile equipment with the driving force.

Thus, during braking, while the handle is being clenched gradually, the controller may receive the changing signal of the braking strength output by the braking strength detecting device 13. In this case, the controller may generate a control signal according to the signal of the braking strength, such that the mobile equipment is no longer provided with the driving force. Meanwhile, the controller may generate a control signal corresponding to the constantly changing signal of the braking strength, to generate an electronic braking force corresponding to the constantly changing distance, such that the mobile equipment may be braked.

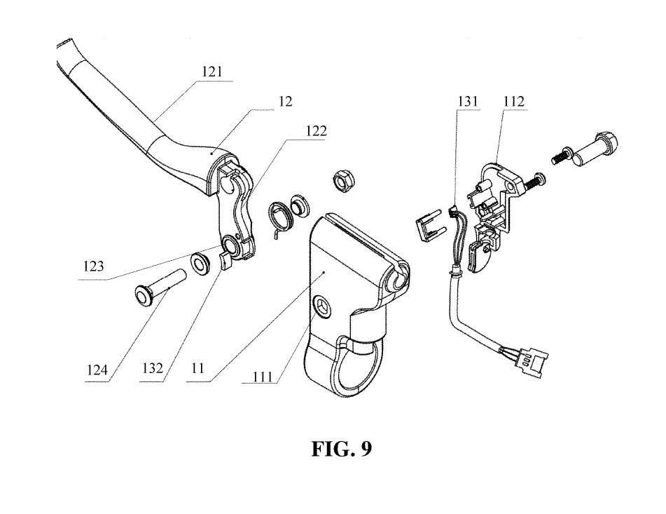

As shown in FIG. 9, the braking strength detecting device 13 may be a Hall element 131. The braking crank device may further include a magnet 132.

The magnet 132 may be arranged for moving with displacement of the handle of the braking crank 12 during braking.

The Hall element 131 may be arranged for detecting strength of a magnetic field generated by the magnet 132 during movement, and generating, according to the strength of the magnetic field detected, the signal of the braking strength corresponding to the movement.

The Hall element 131 may be a linear Hall element.

The magnet 132 may be of magnetic steel (permanent magnet).

As shown in FIG. 9, the magnet 132 may be set on an extending part 122 integral to the handle 121 of the braking crank 12. The extending part 122 may be set with a first hole for connection 123. The braking crank case 11 may be set with a second hole for connection 111 corresponding to the first hole for connection 123.

A braking crank shaft 124 may be arranged for installing the braking crank 11 on the braking crank case 11 by passing through the first hole for connection 123 and the second hole for connection 111.

After an external force has been applied to the handle 121, the braking crank 12 may move within a range of locations along the braking crank shaft 124.

Meanwhile, as shown in FIG. 9, the braking crank case 11 may be set with a Hall base 112. The Hall element 131 may be secured on the Hall base 112. The Hall element 131 may be arranged for not moving with the displacement of the handle 121 of the braking crank 12.

During braking, while a handle 121 of a braking crank is being clenched gradually by a user, the magnet 132 may move with movement of the handle 121 of the braking crank 12. The Hall element 131 may be secured and may not move. Therefore, while the magnet 132 is moving, a location of the Hall element 131 with respect to the magnet 132 may change, such that the Hall element 131 may detect the strength of the magnetic field generated by the magnet at different locations (which may be construed by the Hall element 131 as change in magnetic induction). The strength of the magnetic field at different locations may reflect indirectly the signal of the braking strength corresponding to the locations. The Hall element 131 may convert the detected strength of the magnetic field into a linear analog electric (voltage or current) signal, to generate a linear electronic braking force corresponding to the constantly changing distance under control of a controller.

The Hall element 131 and the magnet 132 may have to be set such that the magnet 132 generates a magnetic field oriented parallel to the Hall element 131 (i.e., a sensing surface of the Hall element is perpendicular to the orientation of the magnetic field), to allow the Hall element 131 to detect accurately the strength of the magnetic field of the magnet 132 at different locations while the magnet 132 is moving.

Thus, during braking, while a handle is being clenched gradually, a controller may receive not only a displacement signal output by a displacement detecting device, but also a linear analog electric signal output by a Hall element 131. In this case, the controller may generate a control signal according to the linear analog electric signal so as to stop providing mobile equipment with a driving force. Meanwhile, the controller may generate a control signal corresponding to the linear analog electric signal, to generate an electronic braking force with linearly increasing strength, such that the mobile equipment may be braked.

As shown in FIG. 9, another auxiliary part, such as a heat shrinkable tube, a screw, a nut, a recovering part (to recover a braking crank 12 after it has moved), a signal line, etc., may be required to set and connect the Hall element 131, the Hall base 112, the braking crank shaft 124, etc.

With a braking crank device according to an embodiment herein, a braking crank 12 is installed on a braking crank case 11. During braking, a braking strength detecting device 13 set inside the braking crank case 11 generates a signal of a braking strength corresponding to movement of a handle of the braking crank 12 while the handle is moving. The signal of the braking strength may be arranged for generating a first force corresponding to a distance by which the handle of the braking crank 12 has moved. A size of the first force may change as the distance changes. The first force is an electronic braking force. During braking, the signal of the braking strength corresponding to the change in the distance by which the handle has moved is generated, thereby generating an electronic braking force corresponding to strength of a braking signal, such that a continuous increasing electronic braking force may be generated during braking, thereby providing a continuous increasing braking force, increasing the braking force, enhancing a braking result. By providing braking with an electronic braking force of a size changing with change in a distance by which a handle of a braking crank has moved, somatosensory control of a size of an electronic braking force by a user is enabled, enhancing a braking precision, improving braking experience, thereby enhancing amenity in braking.

Moreover, a signal corresponding to a braking strength may be detected by coordination between a linear Hall element 131 and a magnet 132, such that the signal of the braking strength corresponding to a distance by which a handle has moved may be detected accurately.

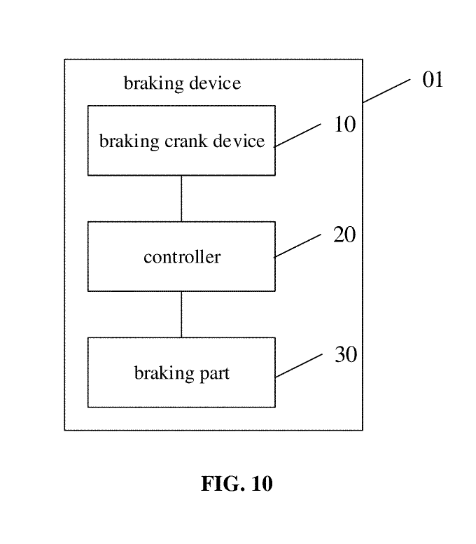

As shown in FIG. 10, a braking device 01 based on an aforementioned embodiment may include a braking crank device 10, a controller 20, and a braking part 30.

As shown in FIG. 8, the braking crank device 10 includes a braking crank case 11, a braking crank, and a braking strength detecting device.

The braking crank 12 is installed on the braking crank case 11.

The braking strength detecting device 13 is set inside the braking crank case 11. The braking strength detecting device may be arranged for: generating, in response to a movement of a handle of the braking crank during braking, a signal of a braking strength corresponding to the movement, and outputting the signal of the braking strength to the controller 20.

The controller 20 may be arranged for: generating, according to the signal of the braking strength, a first control signal; controlling, according to the first control signal, electric braking on a driving part by the braking part 30. A size of a braking force thereof may change as a distance by which the handle of the braking crank has moved changes.

The braking part 30 may brake through a circuit structure. The braking part per se may be the circuit structure. A driving part may be a motor, for example. Rotation of the motor may drive a wheel of the mobile equipment, thereby driving the mobile equipment. The braking part 30 may brake the mobile equipment as follows. An electric current may be applied to the motor (in a duration which may be determined by the controller 20 according to the signal of the braking strength corresponding to the movement), to short circuit a winding of the motor intermittently. When the winding of the motor is short circuited intermittently, rotation of the motor may be stopped, such that no power may be provided to the wheel, thereby braking the mobile equipment.

With a braking crank device 10 according to an embodiment herein, while a handle of a braking crank 12 is being clenched gradually by a user, i.e., while a distance by which the handle has moved is changing gradually, a braking strength detecting device 13 may detect a signal of a braking strength corresponding to a constantly changing distance, and output the generated signal to the controller 20. The controller 20 may constantly output a control signal to the braking part 30 according to the signal of the braking strength, to control the braking part 30 to apply, to the driving part, an electric braking force of a size corresponding to the constantly changing distance.

The controller 20 may further be arranged for generating, according to the signal of the braking strength, a second control signal to stop outputting a driving force that drives mobile equipment (i.e., controlling the driving part to stop generating a driving force).

That is, while the mobile equipment is moving, the signal of the braking strength may instruct the controller 20 to stop providing the mobile equipment with the driving force.

Thus, during braking, while a handle is being clenched gradually, a controller 20 may receive a changing signal of a braking strength output by a braking strength detecting device 13. In this case, the controller 20 may generate a control signal according to the signal of the braking strength to control a driving part to stop providing mobile equipment with a driving force. Meanwhile, the controller 20 may constantly output a control signal to the braking part 30 according to the signal of the braking strength, to control the braking part 30 to apply, to the driving part, an electric braking force of a size corresponding to the constantly changing distance, such that the mobile equipment may be braked.

As shown in FIG. 9, the braking strength detecting device 13 may be a Hall element 131. The braking crank device 10 may further include a magnet 132.

The magnet 132 may be arranged for moving with displacement of the handle of the braking crank 12 during braking.

The Hall element 131 may be arranged for detecting strength of a magnetic field generated by the magnet 132 during movement, and generating, according to the strength of the magnetic field detected, the signal of the braking strength corresponding to the movement.

The Hall element 131 may be a linear Hall element.

The magnet 132 may be of magnetic steel (permanent magnet).

As shown in FIG. 9, the magnet 132 may be set on an extending part 122 integral to the handle 121 of the braking crank 12. The extending part 122 may be set with a first hole for connection 123. The braking crank case 11 may be set with a second hole for connection 111 corresponding to the first hole for connection 123.

A braking crank shaft 124 may be arranged for installing the braking crank 11 on the braking crank case 11 by passing through the first hole for connection 123 and the second hole for connection 111.

After an external force has been applied to the handle 121, the braking crank 12 may move within a range of locations along the braking crank shaft 124.

Meanwhile, as shown in FIG. 9, the braking crank case 11 may be set with a Hall base 112. The Hall element 131 may be secured on the Hall base 112. The Hall element 131 may be arranged for not moving with the displacement of the handle 121 of the braking crank 12.

During braking, while a handle of a braking crank is being clenched gradually by a user, the magnet 132 may move with movement of the handle 121 of the braking crank 12. The Hall element 131 may be secured and may not move. Therefore, while the magnet 132 is moving, a location of the Hall element 131 with respect to the magnet 132 may change, such that the Hall element 131 may detect the strength of the magnetic field generated by the magnet at different locations (which may be construed by the Hall element 131 as change in magnetic induction). The strength of the magnetic field at different locations may reflect indirectly the signal of the braking strength corresponding to the locations. The Hall element 131 may convert the detected strength of the magnetic field into a linear analog electric (voltage or current) signal, to generate a linear electronic braking force corresponding to the constantly changing distance under control of a controller.

The Hall element 131 and the magnet 132 may have to be set such that the magnet 132 generates a magnetic field oriented parallel to the Hall element 131 (i.e., a sensing surface of the Hall element is perpendicular to the orientation of the magnetic field), to allow the Hall element 131 to detect the strength of the magnetic field of the magnet 132 at different locations while the magnet 132 is moving.

Thus, during braking, while a handle is being clenched gradually, a controller may receive not only a displacement signal output by a displacement detecting device, but also a linear analog electric signal output by a Hall element 131. In this case, the controller 20 may generate a control signal according to the linear analog electric signal so as to stop providing mobile equipment with a driving force. Meanwhile, the controller 20 may generate a control signal corresponding to the linear analog electric signal, to generate an electronic braking force with linearly increasing strength, such that the mobile equipment may be braked.

As shown in FIG. 9, another auxiliary part, such as a heat shrinkable tube, a screw, a nut, a recovering part (to recover a braking crank 12 after it has moved), a signal line, etc., may be required to set and connect the Hall element 131, the Hall base 112, the braking crank shaft 124, etc.

Mobile equipment according to an embodiment herein may include the braking device. The braking device may include a braking crank device 10, a controller, and a braking part (not shown in FIG. 4).

The mobile equipment may be an electric bicycle (as shown in FIG. 4), an electric scooter, an electric tricycle, an electric four-wheeler, etc.

With a solution according to an embodiment herein, a braking crank 12 is installed on a braking crank case 11. During braking, a braking strength detecting device 13 set inside the braking crank case 11 generates a signal of a braking strength corresponding to movement of a handle of the braking crank 12 while the handle is moving. The signal of the braking strength may be arranged for generating a first force corresponding to a distance by which the handle of the braking crank 12 has moved. A size of the first force may change as the distance changes. The first force is an electronic braking force. During braking, the signal of the braking strength corresponding to the change in the distance by which the handle has moved is generated, thereby generating an electronic braking force corresponding to strength of a braking signal, such that a continuous increasing electronic braking force may be generated during braking, thereby providing a continuous increasing braking force, increasing the braking force, enhancing a braking result. By providing braking with an electronic braking force of a size changing with change in a distance by which a handle of a braking crank has moved, somatosensory control of a size of an electronic braking force by a user is enabled, enhancing a braking precision, improving braking experience, thereby enhancing amenity in braking.

Moreover, a signal corresponding to a braking strength may be detected by coordination between a linear Hall element 131 and a magnet 132, such that the signal of the braking strength corresponding to a distance by which a handle has moved may be detected accurately.

Solutions according to embodiments herein may be combined with each other as needed as long as no conflict results from the combination.

What described are but embodiments herein and are not intended to limit the scope of the subject disclosure. Any modification, equivalent replacement, and/or the like made within the technical scope of the subject disclosure, as may occur to those skilled in the art, shall be included in the scope of the present disclosure.

1.-14. (canceled)

15. A braking crank device, comprising:
a braking crank case;
a braking crank installed on the braking crank case; and
a braking strength detecting device arranged for generating, in response to a movement of a handle of the braking crank during braking, a signal of a braking strength corresponding to the movement,
wherein the braking strength detecting device is set inside the braking crank case,
wherein the signal of the braking strength is arranged for generating a first force corresponding to a distance by which the handle of the braking crank has moved, wherein a size of the first force changes as the distance changes, wherein the first force is an electronic braking force.

16. The braking crank device of claim 15, wherein the braking strength detecting device is a Hall element, wherein the braking crank device further comprises a magnet,
wherein the magnet is arranged for moving with displacement of the handle of the braking crank during braking,
wherein the Hall element is arranged for: detecting strength of a magnetic field generated by the magnet during movement, and generating, according to the strength of the magnetic field detected, the signal of the braking strength corresponding to the movement.

17. The braking crank device of claim 16, wherein the magnet is set on an extending part integral to the handle,
wherein the extending part is set with a first hole for connection, wherein the braking crank case is set with a second hole for connection corresponding to the first hole for connection,
wherein a braking crank shaft is arranged for installing the braking crank on the braking crank case by passing through the first hole for connection and the second hole for connection.

18. The braking crank device of claim 16, wherein the braking crank case is set with a Hall base, wherein the Hall element is secured on the Hall base, wherein the Hall element is arranged for not moving with the displacement of the handle of the braking crank.

19. The braking crank device of claim 15, wherein the signal of the braking strength is arranged for instructing to stop outputting a driving force that drives mobile equipment.

20. A braking device, comprising a braking crank device, the braking crank device comprising:
a braking crank case;
a braking crank installed on the braking crank case; and
a braking strength detecting device arranged for generating, in response to a movement of a handle of the braking crank during braking, a signal of a braking strength corresponding to the movement,
wherein the braking strength detecting device is set inside the braking crank case,
wherein the braking device further comprises:
a braking part; and
a controller arranged for: generating, according to the signal of the braking strength, a first control signal; controlling, according to the first control signal, electric braking on a driving part by the braking part, with a size of a braking force changing as a distance by which the handle of the braking crank has moved changes,
wherein the braking strength detecting device is arranged for outputting the signal of the braking strength to the controller.

21. The braking device of claim 20, wherein the braking strength detecting device is a Hall element, wherein the braking crank device further comprises a magnet,
wherein the magnet is arranged for moving with displacement of the handle of the braking crank during braking,
wherein the Hall element is arranged for: detecting strength of a magnetic field generated by the magnet during movement, and generating, according to the strength of the magnetic field detected, the signal of the braking strength corresponding to the movement.

22. The braking device of claim 21, wherein the magnet is set on an extending part integral to the handle,
wherein the extending part is set with a first hole for connection, wherein the braking crank case is set with a second hole for connection corresponding to the first hole for connection,
wherein a braking crank shaft is arranged for installing the braking crank on the braking crank case by passing through the first hole for connection and the second hole for connection.

23. The braking device of claim 21, wherein the braking crank case is set with a Hall base, wherein the Hall element is secured on the Hall base, wherein the Hall element is arranged for not moving with the displacement of the handle of the braking crank.

24. The braking device of claim 20, wherein the controller is arranged for generating, according to the signal of the braking strength, a second control signal to stop outputting a driving force that drives mobile equipment.

25. Mobile equipment, comprising the braking device of claim 20.

26. A controlling method, applying to mobile equipment having a first braking part and a second braking part, the controlling method comprising:
acquiring a first operation; determining, according to the first operation, a braking strategy;
determining, according to the braking strategy, a first parameter corresponding to the first braking part and a second parameter corresponding to the second braking part;
controlling, according to the first parameter, first braking on the mobile equipment by the first braking part;
generating a control signal corresponding to the second parameter; and controlling, according to the control signal, second braking on the mobile equipment by the second braking part.

27. The controlling method of claim 26, wherein the first braking part is connected to a moving structure, wherein the mobile equipment further comprises a sensor for detecting a course of the moving structure,
wherein the acquiring a first operation; determining, according to the first operation, a braking strategy comprises:
in response to acquiring the first operation, detecting, using the sensor, a course of the moving structure corresponding to the first operation; and
determining, according to the course, the braking strategy.

28. The controlling method of claim 27, wherein the first parameter indicates a braking strength of the first braking part, wherein the second parameter indicates a braking strength of the second braking part, wherein the braking strategy comprises:
in response to the course being within a first range, setting both the first parameter and the second parameter to zero;
in response to the course being within a second range, setting the first parameter to be greater than zero and the second parameter to zero; or setting the first parameter to zero and the second parameter to be greater than zero; and/or
in response to the course being within a third range, setting both the first parameter and the second parameter to be greater than zero,
wherein the course within the first range is less than the course within the second range, wherein the course within the second range is less than the course within the third range.

29. The controlling method of claim 27, wherein the first parameter indicates a braking strength of the first braking part, wherein the second parameter indicates a braking strength of the second braking part, wherein the braking strategy comprises:
in response to the course being within a fourth range, setting both the first parameter and the second parameter to zero; and/or
in response to the course being within a fifth range, setting both the first parameter and the second parameter to be greater than zero,
wherein the course within the fourth range is less than the course within the fifth range.

30. The controlling method of claim 27, wherein the first parameter indicates a braking strength of the first braking part, wherein the second parameter indicates a braking strength of the second braking part, wherein the braking strategy comprises:
in response to the course being within a sixth range, setting the first parameter to be greater than zero and the second parameter to zero; or setting the first parameter to zero and the second parameter to be greater than zero; and/or
in response to the course being within a seventh range, setting both the first parameter and the second parameter to be greater than zero,
wherein the course within the sixth range is less than the course within the seventh range.

31. The controlling method of claim 27, wherein the braking strategy further comprises:
in response to the first parameter being greater than zero, increasing the first parameter as the course increases; and/or
in response to the second parameter being greater than zero, increasing the second parameter as the course increases.

32. The controlling method of claim 26, wherein the controlling, according to the control signal, second braking on the mobile equipment by the second braking part comprises:
controlling the second braking part to determine, according to the control signal, a locking duration and a driving duration of a driving part within a period of time pre-determined;
controlling the driving part to stop driving within the locking duration.

33. Mobile equipment, having a first braking part and a second braking part, the mobile equipment comprising a processor arranged for performing the controlling method of claim 26.

34. The mobile equipment of claim 33, wherein the first braking part is connected to a moving structure, wherein the mobile equipment further comprises a sensor for detecting a course of the moving structure,
wherein the sensor is arranged for: in response to acquiring the first operation, detecting a course of the moving structure corresponding to the first operation,
wherein the processor is further arranged for: determining, according to the course, the braking strategy.
